(19) United States
(12) Patent Application Publication
(10) Pub. No.: US 2016/0346783 A1
(43) Pub. Date: Dec. 1, 2016

(54) ADJUSTABLE DEVICE FOR MULTI-CHANNEL PIPETTE

(71) Applicant: Mo Bio Laboratories, Inc., Carlsbad, CA (US)

(72) Inventors: Vince MORONEY, Rancho Santa Fe, CA (US); Mark N. BROLASKI, Encinitas, CA (US)

(21) Appl. No.: 14/724,739

(22) Filed: May 28, 2015

(51) Int. Cl. B01L 9/00

(52) U.S. Cl. CPC B01L 9/54; B01L 2200/0605; B01L 2300/0809

(57) ABSTRACT

Provided is a device including a base, a pipette support, and a wall. The pipette support includes an aperture. A width of the aperture is within a range of 70 to 90 mm and a length of the aperture is within a range of 100 to 140 mm. A wall connects the base with the pipette support. The distance between the pipette support and the base is adjustable. Also provided are methods of pipetting. The methods include placing a multi-well plate below an aperture of the pipette support, inserting a multi-channel pipette comprising pipette tips into an aperture of a pipette support such that the body of the pipette rests on an edge of the aperture, and adjusting a distance between the pipette support and the base.

### FIELD OF THE DISCLOSURE

This disclosure generally relates to devices and methods for multi-channel pipetting.

### BACKGROUND

There are various challenges to accurate and reproducible pipetting. For example, pipette tips attached to a handheld multi-channel pipette may not extend evenly into wells of a multi-well plate due to variations in user control of the pipette over the course of an experiment. This may lead to uneven aspiration of supernatant or disruption of a pellet. Additionally, manual use of multi-channel pipettes can be physically strenuous and may cause repetitive stress injuries in laboratory environments.

Traditionally, existing pipetting aids that seek to limit process variations suffer from the requirement of using platform-specific equipment (e.g., dedicated multi-channel pipettes) and/or consumables.

### SUMMARY

Thus, there is a need for a universal pipetting aid that can accept any standardized (e.g., SBS-formatted) multichannel pipette. Provided in some embodiments is a device with a base, a pipette support, and a wall. In some embodiments, the pipette support has an aperture. In some embodiments, a distance between the pipette support and the base is adjustable. In some embodiments, the wall connects the base with the pipette support. In some embodiments, a width of the aperture is within a range of 70 to 90 mm. In some embodiments, a length of the aperture is within a range of 100 to 140 mm.

As an exemplary advantage, the device may result in the even extension of pipette tips into wells of a multi-well plate, reducing the burden on the user. As a further exemplary advantage, the device may provide even or consistent aspiration of supernatant from wells of the plate, reducing reliance on the skill of the user. As a further exemplary advantage, this may avoid disruption of a pellet in wells of the plate. As a further exemplary advantage, the device may be portable. As a further exemplary advantage, the device may reduce risk or occurrence of repetitive stress injuries by reducing the physical burden of holding a multichannel pipette during repeated aspiration and dispensing steps. As a further exemplary advantage, the device may take up less space than other devices for pipetting or may weigh less than other devices. As a further exemplary advantage, the device may be adjusted manually or may not require electronics, hydraulics, or other non-manual power.

In some embodiments, the pipette support comprises an aperture. In some embodiments, a width of the aperture is within a range of 70 to 90 mm. In some embodiments, a width of the aperture is within a range of 70 to 75 mm. In some embodiments, a length of the aperture is within a range of 100 to 140 mm. In some embodiments, a length of the aperture is within a range of 100 to 110 mm. In some embodiments, the width of the aperture is approximately 72 mm and the length of the aperture is approximately 109 mm. In some embodiments, the width or the length of the aperture may be approximately the size of a body of a multi-channel pipette, e.g., an 8-channel or 12-channel pipette.

In some embodiments, the wall connects the base with the pipette support. As an exemplary advantage, the connection of the wall to the base and pipette support may allow the device to be manufactured as two units, thereby decreasing the cost for manufacturing or increasing durability of the device.

In some embodiments, a distance between the pipette support and the base is adjustable. In some embodiments, the distance between the pipette support and the base is manually adjustable. In some embodiments, a user may adjust the base, such as up and down, to a desired distance from the pipette support. In other embodiments, a user may adjust the pipette support, such as up and down, to a desired distance from the base. As an exemplary advantage, a user may adjust the distance quickly and reproducibly.

In some embodiments, the distance between the pipette support and the base may be adjusted over a range from 30 mm to 200 mm. In some embodiments, the distance between the pipette support and the base may be adjusted to approximately the length of a pipette tip, e.g., a 2 μL, 10 μL, 20 μL, 100 μL, 200 μL, or 1 mL pipette tip. In some embodiments, the distance between the pipette support and the base may be adjusted over a range from 74 mm to 127 mm.

As an exemplary advantage, the distance between the pipette support and the base may be adjusted such that a pipette tip attached to a multi-channel pipette with its body resting on an edge of the aperture extends to a desired distance above wells of a multi-well plate below the aperture. As a further exemplary advantage, the distance between the pipette support and the base may be adjusted such that a pipette tip attached to a multi-channel pipette with its body resting on an edge of the aperture extends to a desired depth within wells of a multi-well plate below the aperture. As a further exemplary advantage, distal ends of the tips may align at approximately the same distance from the bottom of respective wells.

In some embodiments, the base is moveable relative to the wall. In some embodiments, the base is attached to the wall with a fastener that extends through the wall. In some embodiments, an attachment force between the base and the wall is adjustable. In some embodiments, an attachment force between the base and the wall is manually adjustable. In some embodiments, the fastener is a screw or knob. In some embodiments, the fastener attaches the base to the wall at a desired distance from the pipette support.

As an exemplary advantage, the fastener may be adjustable or removable, allowing for adjustment of the base relative to the pipette support. As a further exemplary advantage, the base may be attached over a range of distances relative to the pipette support, allowing the device to be used for different pipetting purposes.

In some embodiments, a protrusion extends from the base through the wall. As an exemplary advantage, the protrusion extending through the wall may maintain the base in a position parallel to the pipette support.

In some embodiments, the pipette support is moveable relative to the wall. In some embodiments, the pipette support is attached to the wall with a fastener that extends through the wall. In some embodiments, an attachment force between the pipette support and the wall is adjustable. In some embodiments, an attachment force between the pipette support and the wall is manually adjustable. In some embodiments, the fastener is a screw or knob. In some embodiments, the fastener attaches the pipette support to the wall at a desired distance from the base.

As an exemplary advantage, the fastener may be adjustable or removable, allowing for adjustment of the pipette support relative to the base. As a further exemplary advantage, the pipette support may be attached over a range of distances relative to the base, allowing the device to be used for different pipetting purposes.

In some embodiments, a protrusion extends from the pipette support through the wall. As an exemplary advantage, the protrusion extending through the wall may maintain the pipette support in a position parallel to the base.

In some embodiments, a surface of the wall contains markings indicating a distance between the pipette support and the base. In some embodiments, the markings are a scale that indicates a value relative to the distance between the pipette support and the base. In some embodiments, the distance is indicated by the location of the fastener or protrusion relative to the values of the markings.

As an exemplary advantage, the markings may allow for the distance between the pipette support and the base to be known, recorded, or controlled. As a further exemplary advantage, the distance between the pipette support and the base may be reproducible. As a further exemplary advantage, the distance may be returned to a desired distance following adjustment to a different distance. For example, a user can perform a first pipetting operation at a first distance, adjust the device to perform a second pipetting operation at a second distance, and then readjust the device back to the first distance to repeat the first pipetting operation.

In some embodiments, the device includes a stabilizing element. In some embodiments, the stabilizing element includes more than one component. In some embodiments, the stabilizing element includes a clip, clasp, or screw. In some embodiments, the stabilizing element is flexible. In some embodiments, the stabilizing element is adjustable. In some embodiments, a component of the stabilizing element is spaced about 85 mm from another component of the stabilizing element. In some embodiments, a component of the stabilizing element is spaced about 127 mm from another component of the stabilizing element.

As an exemplary advantage, the stabilizing element may serve as a guide for the placement of a multi-well plate below the aperture. As a further exemplary advantage, the stabilizing element may serve to secure a multi-well plate such that it does not change positions relative to the aperture or slide off of a surface, such as the base.

In some embodiments, the pipette support is fixed relative to the wall. In other embodiments, the base is fixed relative to the wall. In some embodiments, the wall is perpendicular to the base or the pipette support. As an exemplary advantage, when components of the device are fixed, the variability of the orientation of the components with respect to one another may be reduced.

In some embodiments, the dimensions of the device are approximately 194 mm length×158 mm width×138 mm height, with the wall having dimensions of approximately 194 mm length×134 mm height, the pipette support having dimensions of approximately 194 mm length×138 mm width, and the base having dimensions of approximately 179 mm length×132 mm width or approximately 194 mm length×138 mm width. In some embodiments, the volume occupied by the device is approximately 3030 mm³ to approximately 4229 mm³ or does not exceed approximately 18000 mm³. In some embodiments, the device is lightweight. In some embodiments, the mass of the device is within a range from approximately 500 g to approximately 950 g. In some embodiments, the mass of the device does not exceed approximately 936 g.

As an exemplary advantage, the device may occupy less space, such as on a table or bench, than another device, such as an automated pipetting system. As a further exemplary advantage, the device may weigh less than another device, such as an automated pipetting system. As a further exemplary advantage, the size or mass of the device may facilitate the ability of a user to transport or move the device. Thus, as a further exemplary advantage, the device may be portable. As a further exemplary advantage, the device may not require a power source such as electricity. In some embodiments, the device may include a power source such as electricity. In some embodiments, the device may contain a lighting device to improve visibility while pipetting.

Provided in some embodiments are methods of pipetting. In some embodiments, the method includes placing a multi-well plate below an aperture of a pipette support. In some embodiments, the aperture has a width within a range of 70 to 90 mm and a length within a range of 100 to 140 mm. In some embodiments, the method includes inserting a multi-channel pipette comprising pipette tips into the aperture of the pipette support such that a body of the multi-channel pipette rests on an edge of the aperture. In some embodiments, the method includes adjusting a distance between the pipette support and the multi-well plate.

In some embodiments, the pipette is inserted into the aperture such that a body of the pipette rests on an edge of the aperture with the tips extending through the aperture. In some embodiments, the aperture has a width within a range of 70 to 90 mm. In some embodiments, the aperture has a width within a range of 70 to 75 mm. In some embodiments, the aperture has a length within a range of 100 to 140 mm. In some embodiments, the aperture has a length within a range of 100 to 110 mm. In some embodiments, the width of the aperture is approximately 72 mm and the length of the aperture is approximately 109 mm. In some embodiments, the width or the length of the aperture may be approximately the size of the multi-channel pipette, e.g., an 8-channel or 12-channel pipette.

As an exemplary advantage, when the body of the multi-channel pipette is rested on an edge of the aperture, the body of the pipette, e.g., along a plane from a first to a last channel, may be parallel with a row or column of wells of a multi-well plate resting below the aperture, for example, such that distal ends of the tips are at an equal distance from the bottom of respective wells. As a further exemplary advantage, the length of the aperture may be such that the body of a 12-channel pipette held parallel to the length of the aperture would rest on an edge of the aperture and would not fall through the aperture. As a further exemplary advantage, the width of the aperture may be such that the body of an 8-channel pipette held parallel to the width of the aperture would rest on an edge of the aperture and would not fall through the aperture.

In some embodiments, the method includes adjusting a distance between the pipette support and a base. In some embodiments, the distance is manually adjusted. In some embodiments, the method includes adjusting an attachment force between the base and a wall. In some embodiments, the base is attached to the wall with a fastener that extends through the wall. In some embodiments, a protrusion extends from the base through the wall.

In some embodiments, the method includes decreasing the attachment force between the base and the wall (such as by loosening the fastener), manually adjusting the base to increase or decrease the distance between the base and the pipette support, and increasing the attachment force, such as by tightening the fastener.

In other embodiments, the method includes adjusting an attachment force between the pipette support and a wall. In some embodiments, the pipette support is attached to the wall with a fastener that extends through the wall. In some embodiments, a protrusion extends from the pipette support through the wall.

In some embodiments, the method includes decreasing the attachment force between the pipette support and the wall (such as by loosening the fastener), manually adjusting the pipette support to increase or decrease the distance between the pipette support and the base, and increasing the attachment force, such as by tightening the fastener.

In some embodiments, the wall may be attached to a physical surface, such as a lab wall. Exemplary attachment mechanisms include screws, bolts, etc. In some embodiments, the base of the device may not touch another lab surface, such as a lab bench.

In some embodiments, the distance between the pipette support and the base is adjusted to between 30 and 200 mm. In some embodiments, the distance between the pipette support and the base is adjusted to approximately the length of a pipette tip, e.g., a 2 μL 10 μL, 20 μL, 100 μL, 200 μL, or 1 mL pipette tip. In some embodiments, the distance between the pipette support and the base is adjusted to between approximately 74 mm and approximately 127 mm.

As an exemplary advantage, the distance may be adjusted to accommodate the use of various sizes of pipette tips. As a further exemplary advantage, the distance may be adjusted to accommodate various experimental protocols. As a further exemplary advantage, the distance may be adjusted to accommodate various volumes of compositions to be dispensed into or aspirated from the wells.

In some embodiments, a surface of the wall contains markings indicating a distance between the pipette support and the base. In some embodiments, the markings are a scale to indicate a value relative to the distance between the pipette support and the base. In some embodiments, the distance is indicated by the location of the fastener or protrusion relative to the values of the markings. In some embodiments, the distance between the pipette support and the base is adjusted such that the fastener or protrusion aligns with a marking on the wall.

As an exemplary advantage, the markings may allow for the distance between the pipette support and the base to be known, recorded, or controlled. As a further exemplary advantage, the distance between the pipette support and the base may be reproducible. As a further exemplary advantage, the distance may be returned to a desired distance following adjustment to a different distance, such as after use by another user or for a different experimental protocol.

In some embodiments, the method includes placing the multi-well plate in a stabilizing element. As an exemplary advantage, the stabilizing element may serve as a guide for the placement of a multi-well plate below the aperture. In some embodiments, the stabilizing element is adjusted such that a multi-well plate resting below the aperture of the pipette support is aligned with the aperture. As a further exemplary advantage, the stabilizing element may serve to secure a multi-well plate on a surface, such as on the base, such that it does not change positions or slide off of the surface.

In some embodiments, the method includes positioning the tips above wells of the multi-well plate. In some embodiments, the method includes positioning the tips within wells of the multi-well plate. In some embodiments, the method includes dispensing a composition into wells of the multi-well plate. In some embodiments, the method includes aspirating a composition from wells of the multi-well plate.

As an exemplary advantage, the method may allow for alignment of the pipette tips above the wells of the plate such that approximately the same amount of a composition is dispensed into wells of a row or column of the plate. As a further exemplary advantage, the method may allow the aspiration of approximately the same amount of a composition from wells of a row or column of the plate. As a further exemplary advantage, the method may result in better reproducibility of volumes dispensed into the wells or of volumes aspirated from the wells than an alternative method, such as manual pipetting without the use of a device. As a further exemplary advantage, the method may allow for aspiration of a composition, such as a supernatant, from the wells without disturbing a pellet, such as that resulting from centrifugation of the plate.

In some embodiments, the method includes removing the pipette from the aperture, and re-inserting the pipette into the aperture. In some embodiments, the tips are ejected from the pipette and fresh tips are attached. In some embodiments, the pipette support contains markings or grooves to facilitate placement of the pipette on an edge, such as the long or the short edge, of the aperture. As an exemplary advantage, the markings or grooves may facilitate the alignment of the pipette tips with rows or columns of the multi-well plate.

As an exemplary advantage, the method may result in better alignment of the pipette tips above the wells, or within the wells as compared to other methods. As a further exemplary advantage, the methods may allow for more consistent pipetting. As a further exemplary advantage, the method may result in reduced pipetting error. As a further exemplary advantage, the method may decrease training time, such as by decreasing the necessary techniques that may be associated with pipetting by other methods. As a further exemplary advantage, the methods may decrease user fatigue as compared with other methods.

### BRIEF DESCRIPTION OF DRAWINGS

FIG. 1A illustrates an exemplary device 100 according to embodiments of the disclosure.

FIG. 1B illustrates exemplary device 100 from an alternate view as compared with FIG. 1A.

FIG. 2A illustrates an exemplary device 200 according to embodiments of the disclosure.

FIG. 2B illustrates exemplary device 200 from an alternate view as compared with FIG. 2A.

FIG. 3A illustrates an exemplary device 300 according to embodiments of the disclosure.

FIG. 3B illustrates exemplary device 300 from an alternate view as compared with FIG. 3A.

FIG. 4 illustrates exemplary method 400 of pipetting.

### DETAILED DESCRIPTION

In the following description of embodiments, reference is made to the accompanying drawings which form a part hereof, and in which shown by way of illustration are specific embodiments that can be practiced. It is to be understood that other embodiments can be used and structural changes can be made without departing from the scope of the disclosed embodiments.

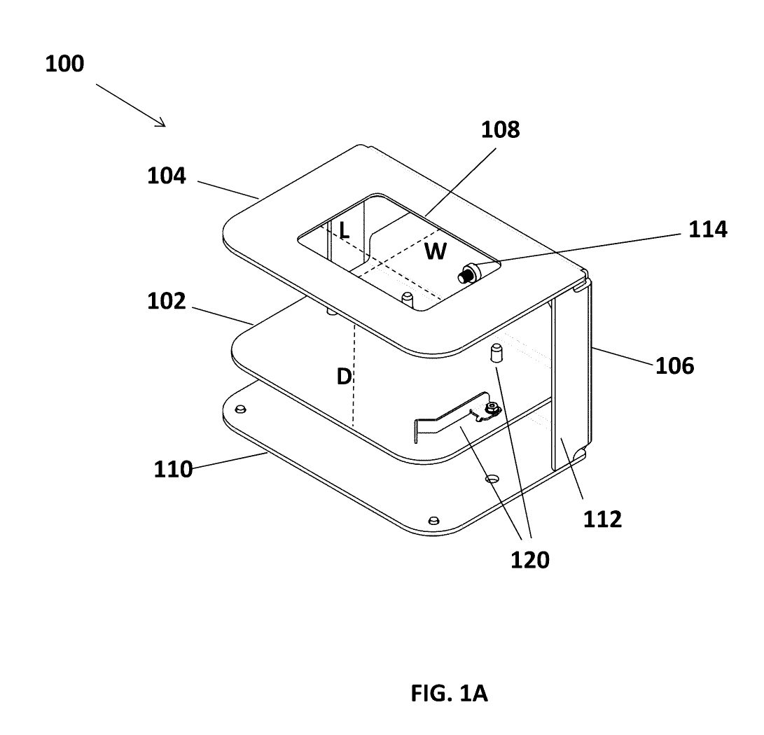

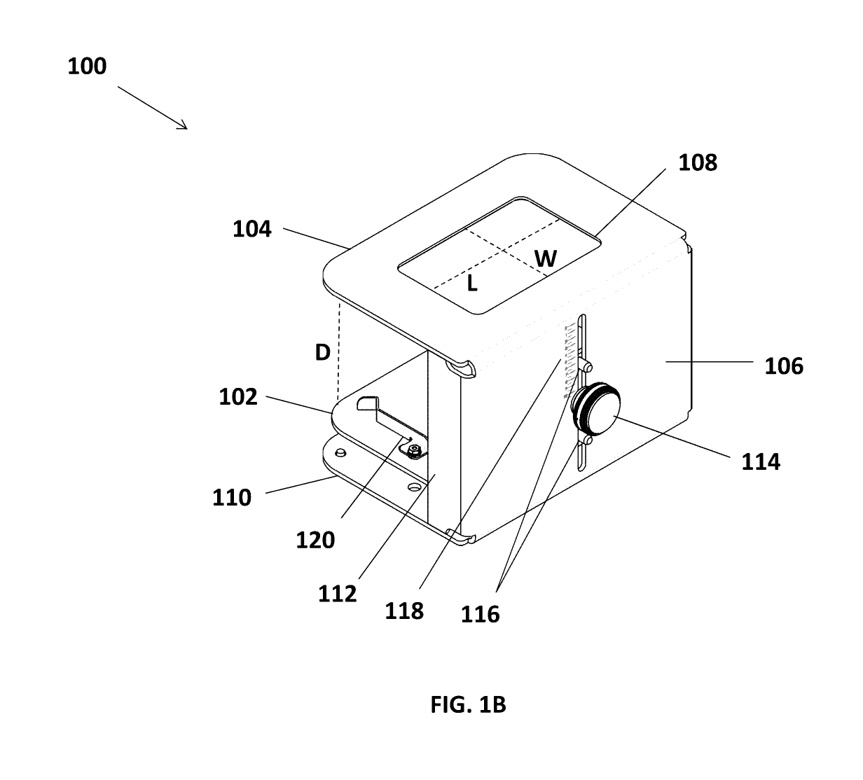

FIG. 1A illustrates an exemplary device 100 in accordance with an embodiment. Device 100 includes a base 102, a pipette support 104, and a wall 106. The pipette support 104 has an aperture 108. A width W of the aperture 108 is within a range of 70 to 90 mm. A length L of the aperture 108 is within a range of 100 to 140 mm. The wall 106 connects the base 102 with the pipette support 104. A distance D between the pipette support 104 and the base 102 is adjustable.

Aperture 108 is defined by the material of the pipette support. The material surrounds the aperture to give it a width W and a length L. In some embodiments, the aperture is centered in the pipette support.

As an exemplary advantage, device 100 may cost less than other automated or semi-manual devices for pipetting. As a further exemplary advantage, device 100 may result in the even extension of pipette tips into wells of a multi-well plate. As a further exemplary advantage, this may result in even or consistent aspiration of supernatant from wells of the plate. As a further exemplary advantage, this may prevent disruption of a pellet in wells of the plate. As a further exemplary advantage, device 100 may be portable. As a further exemplary advantage, device 100 may take up less space than other devices for pipetting or may weigh less than other devices.

The pipette support 104 comprises an aperture 108. A width W of the aperture 108 is within a range of 70 to 90 mm. The width W of the aperture 108 may be within a range of 70 to 75 mm. A length L of the aperture 108 may be within a range of 100 to 140 mm. The length L of the aperture 108 may be within a range of 100 to 110 mm. The width W of the aperture 108 may be approximately 72 mm and the length L of the aperture 108 may be approximately 109 mm. The width W or the length L of the aperture 108 may be about the size of a body of a multi-channel pipette, e.g., an 8-channel or 12-channel pipette.

The aperture 108 may be rectangular. The width W or the length L of the aperture 108 may be dimensions of the rectangular aperture 108. The width W and length L of the aperture may be different for some embodiments. The minimum width W of an aperture may be approximately the size of the body of an 8-channel pipette. The maximum width W may be such that an 8-channel pipette aligned parallel to the width W would not fall through the aperture 108. The minimum length L of an aperture may be approximately the size of the body of a 12-channel pipette. The maximum length L may be such that a 12-channel pipette aligned parallel to the length L would not fall through the aperture 108.

In some embodiments, the aperture is not rectangular. In those embodiments, the width W of an aperture may be understood to include any two points on the perimeter of the aperture that is sufficiently wide to permit tips attached to an 8-channel pipette to pass through and sufficiently narrow so that a body of an 8-channel pipette can rest on the two points. In those embodiments, the length L of an aperture may be understood to include any two points on the perimeter of the aperture that is sufficiently wide to permit tips attached to a 12-channel pipette to pass through and sufficiently narrow so that a body of a 12-channel pipette can rest on the two points. Some non-rectangular apertures may have more than one width W and more than one length L.

As an exemplary advantage, when the body of a multi-channel pipette is rested on an edge of the aperture, a length of the body of the pipette, such as along the channels, may be parallel with rows or columns of wells of a multi-well plate, for example, such that distal ends of tips attached to the pipette are at an equal distance from the bottom of respective wells of a multi-well plate resting below the aperture. As a further exemplary advantage, the length of the aperture may be such that the body of a 12-channel pipette held parallel to the length of the aperture would rest on an edge of the aperture and would not fall through the aperture. As a further exemplary advantage, the width of the aperture may be such that the body of an 8-channel pipette held parallel to the width of the aperture would rest on an edge of the aperture and would not fall through the aperture.

The wall 106 connects the base 102 with the pipette support 104. The base 102 is connected to the wall 106 using a fastener 114 described below with respect to FIG. 1B. The wall 106 may be a solid structure connecting the base 102 with the pipette support 104. The wall 106 may be attached to or may be continuous with a wall support 110. The device may further include a side wall 112. The wall 106 may comprise any structure that connects the base 102 with the pipette support 104 and that is sufficiently rigid to support the pipette support. The wall support 110 may rest on a surface (a work bench, e.g.). The wall 106 may be a solid structure or may contain legs or feet for supporting device 100. The wall support 110 may comprise any structure connected to the wall 106 that stably supports the wall 106 and pipette support 104.

As an exemplary advantage, the connection of the wall 106 to the base 102 and pipette support 104 may allow device 100 to be manufactured as two units, thereby decreasing the cost for manufacturing or increasing durability of device 100. As a further exemplary advantage, the connection of components of device 100 may allow it to be transported easily. As a further exemplary advantage, the connection of components of device 100 may allow it to be portable. As a further exemplary advantage, the connection of components of device 100 may allow the device to stand without external aid, such as on a table or bench.

A distance D between the pipette support 104 and the base 102 is adjustable. The distance between the pipette support 104 and the base 102 may be manually adjustable. As used herein, the term “manually adjustable” can be understood to refer to a component of the device that can be raised and lowered by the human hand with moderate force and without an external power source. As an exemplary advantage, a user may adjust the base 102 manually, such as up and down, to a desired distance D. As a further exemplary advantage, the user may adjust the distance D quickly and reproducibly.

The distance D between the pipette support 104 and the base 102 is between 30 and 200 mm. The distance D between the pipette support 104 and the base 102 may be approximately the length of a pipette tip, e.g., a 2 μL, 10 μL, 20 μL, 100 μL, 200 μL, or 1 mL pipette tip. The distance D between the pipette support 104 and the base 102 may be between 74 and 127 mm.

As an exemplary advantage, the distance D between the pipette support 104 and the base 102 may be such that a pipette tip attached to a multi-channel pipette with its body resting on an edge of the aperture 108 extends to a desired distance above wells of a multi-well plate below the aperture 108. As a further exemplary advantage, the distance D between the pipette support 104 and the base 102 may be such that a pipette tip attached to a multi-channel pipette with its body resting on an edge of the aperture 108 extends to a desired depth within wells of a multi-well plate below the aperture 108. As a further exemplary advantage, distal ends of the tips may align at approximately the same distance from the bottom of respective wells of a multi-well plate.

FIG. 1B illustrates exemplary device 100 from an alternate perspective. The base 102 is attached to the wall 106 with a fastener 114 that extends through the wall 106. An attachment force between the base 102 and the wall 106 is adjustable. The attachment force may be adjustable over a range. For example, at a minimum attachment force, the base 102 may not be fixedly attached to the wall 106 so that the base 102 can move freely relative to the wall 106. At a maximum force, the base 102 may be immobile relative to the wall 106 when subjected to moderate human force. At intermediate forces, the base 102 may be moveable relative to the wall 106 under moderate human force. The attachment force between the base 102 and the wall 106 may be manually adjustable. The fastener 114 may be a screw or knob. The fastener 114 clamps the base 102 to the wall 106 at a desired distance D from the pipette support 104.

As an exemplary advantage, the fastener 114 may be adjustable or removable, allowing for removal of the base 102 or adjustment of the base 102 relative to the pipette support 104. As a further exemplary advantage, the base 102 may be attached over a range of distances D relative to the pipette support 104.

In some embodiments, base 102 is stabilized relative to wall 106. In the embodiment illustrated in FIGS. 1A and 1B, a protrusion 116 extends from the base 102 through the wall 106. As an exemplary advantage, the protrusion 116 may maintain the base 102 in a position parallel to the pipette support 104 by resisting rotation of base 102 about fastener 114. In some embodiments, the wall 106 may contain preset grooves or holes with tabs (not shown) for stabilizing or fixing the base 102 over the range of distances relative to the pipette support 104. In some embodiments, the base 102 may be supported by a protrusion attached to the wall 106. As will be readily understood by one of ordinary skill in the art, other structural features could stabilize the base relative to the wall without deviating from the scope of this disclosure.

A surface of the wall 102 contains markings 118 indicating a distance D between the base 102 and the pipette support 104. The markings 118 may include a scale that indicates a value relative to the distance D between the base 102 and the pipette support 104. The distance D may be indicated by the location of the fastener 114 or protrusion 116 relative to the values of the markings 118.

As an exemplary advantage, the markings 118 may allow for the distance D between the pipette support 104 and the base 102 to be known, recorded, or controlled. As a further exemplary advantage, the distance D between the pipette support 104 and the base 102 may be reproducible. The distance D may be returned to a desired distance D1 following adjustment to a different distance D2, such as after use by another user or for a different experimental protocol.

Returning to FIG. 1A, device 100 includes a stabilizing element 120. The stabilizing element 120 may include more than one component, such as a clip, clasp, or screw. The stabilizing element 120 may be flexible. The stabilizing element 120 may be adjustable. A component of the stabilizing element 120 may be spaced approximately 85 mm from another component of the stabilizing element 120. A component of the stabilizing element 120 may be spaced approximately 127 mm from another component of the stabilizing element 120.

The spacing of the components of the stabilizing element 120 from one another may be approximately the width or length of a multi-well plate. Components of the stabilizing element 120 may be located at both ends of the width of the plate, both ends of the length of the plate, or a combination thereof. The stabilizing element 120 may be aligned with the aperture 108 of the pipette support 104. Thus, components of the stabilizing element 120 may delineate an area in which to place the multi-well plate, such as below the aperture 108 of the pipette support 104. The stabilizing element 120 may contain a spring or other adjustable component. Thus, the stabilizing element 120 may be adjusted to allow for the placement of a plate below the aperture 108 of the pipette support 104 and readjusted to secure the plate.

As an exemplary advantage, the stabilizing element 120 may serve as a guide for the placement of a multi-well plate below the aperture 108 of the pipette support 104. As a further exemplary advantage, the stabilizing element 120 may serve to secure a multi-well plate on a surface, such as the base 102, such that it does not change positions, such as relative to the aperture 108, or slide off of the surface.

The pipette support 104 is fixed relative to the wall 106. The wall 106 is perpendicular to the base 102 or the pipette support 104.

As an exemplary advantage, when components of device 100 are fixed, the variability of the orientation of the components with respect to one another may be reduced. As a further exemplary advantage, device 100 may stand without external support, such as on the surface of a bench or table.

The dimensions of device 100 are approximately 194 mm length×158 mm width×138 mm height, with the wall having dimensions of approximately 194 mm length×134 mm height, the pipette support having dimensions of approximately 194 mm length×138 mm width, and the base having dimensions of approximately 179 mm length×132 mm width or approximately 194 mm length×138 mm width. The area occupied by device 100 is in a range from approximately 3030 mm³ to approximately 4229 mm³ or does not exceed approximately 18000 mm³. Device 100 may be lightweight. The mass of device 100 may be between 500 g and 950 g.

As an exemplary advantage, device 100 may occupy less space on a table or bench than another device, such as an automated pipetting system. As a further exemplary advantage, device 100 may weigh less than another device, such as an automated pipetting system. As a further exemplary advantage, the size or mass of device 100 may facilitate the ability of a user to transport, move, or store device 100. Thus, as a further exemplary advantage, device 100 may be portable. As a further exemplary advantage, device 100 may not require a power source such as electricity.

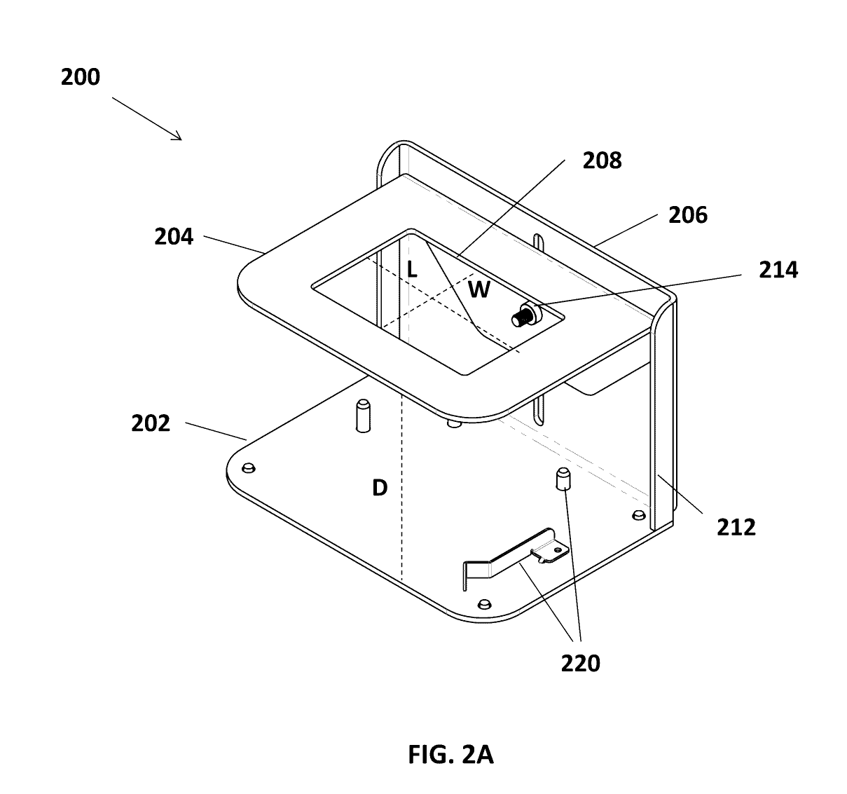

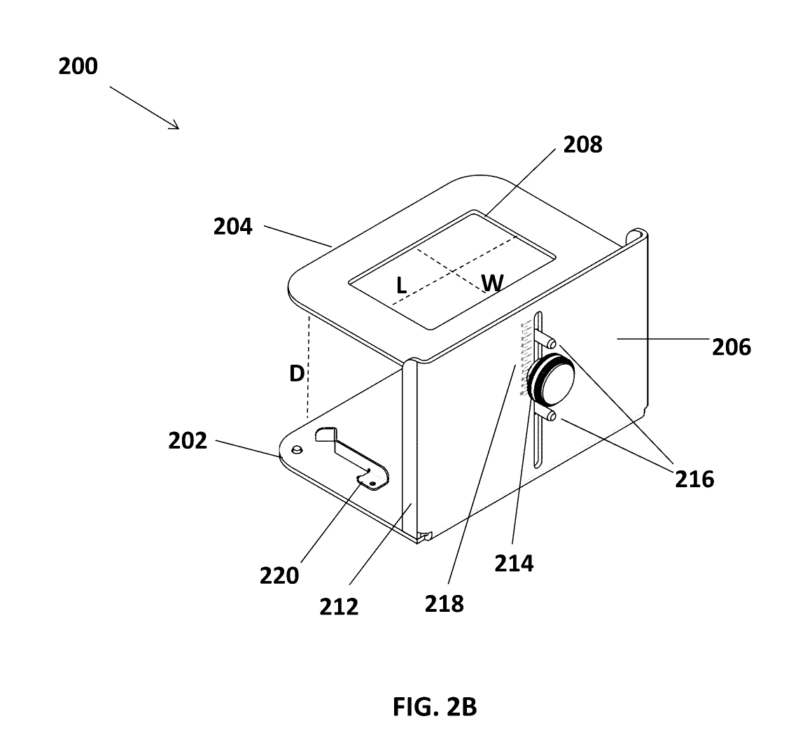

FIG. 2A illustrates an exemplary device 200 in accordance with an embodiment. Device 200 includes a base 202, a pipette support 204, and a wall 206. The pipette support 204 has an aperture 208. A width W of the aperture 208 is within a range of 70 to 90 mm. A length L of the aperture 208 is within a range of 100 to 140 mm. The wall 206 connects the base 202 with the pipette support 204. A distance D between the pipette support 204 and the base 202 is adjustable.

As an exemplary advantage, device 200 may cost less than other automated or semi-manual devices for pipetting. As a further exemplary advantage, device 200 may result in the even extension of pipette tips into wells of a multi-well plate. As a further exemplary advantage, this may result in even or consistent aspiration of supernatant from wells of the plate. As a further exemplary advantage, this may prevent disruption of a pellet in wells of the plate. As a further exemplary advantage, device 200 may be portable. As a further exemplary advantage, device 200 may take up less space than other devices for pipetting or may weigh less than other devices.

The pipette support 204 comprises an aperture 208. A width W of the aperture 208 is within a range of 70 to 90 mm. The width W of the aperture 208 may be within a range of 70 to 75 mm. A length L of the aperture 208 may be within a range of 200 to 140 mm. The length L of the aperture 208 may be within a range of 200 to 110 mm. The width W of the aperture 208 may be approximately 72 mm and the length L of the aperture 208 may be approximately 109 mm. The width W or the length L of the aperture 208 may be about the size of a body of a multi-channel pipette, e.g., an 8-channel or 12-channel pipette.

The aperture 208 may be rectangular. The width W or the length L of the aperture 208 may be dimensions of the rectangular aperture 208. The width W and length L of the aperture may be different for some embodiments. The minimum width W of an aperture may be approximately the size of the body of an 8-channel pipette. The maximum width W may be such that an 8-channel pipette aligned parallel to the width W would not fall through the aperture 208. The minimum length L of an aperture may be approximately the size of the body of a 12-channel pipette. The maximum length L may be such that a 12-channel pipette aligned parallel to the length L would not fall through the aperture 208.

In some embodiments, the aperture is not rectangular. In those embodiments, the width W of an aperture may be understood to include any two points on the perimeter of the aperture that is sufficiently wide to permit tips attached to an 8-channel pipette to pass through and sufficiently narrow so that a body of an 8-channel pipette can rest on the two points. In those embodiments, the length L of an aperture may be understood to include any two points on the perimeter of the aperture that is sufficiently wide to permit tips attached to a 12-channel pipette to pass through and sufficiently narrow so that a body of a 12-channel pipette can rest on the two points. Some non-rectangular apertures may have more than one width W and more than one length L.

As an exemplary advantage, when the body of a multi-channel pipette is rested on an edge of the aperture, a length of the body of the pipette may be parallel with rows or columns of a multi-well plate, for example, such that distal ends of tips attached to the pipette are at an approximately equal distance from the bottom of respective wells of the multi-well plate resting below the aperture. As a further exemplary advantage, the length of the aperture may be such that the body of a 12-channel pipette held parallel to the length of the aperture would rest on an edge of the aperture and would not fall through the aperture. As a further exemplary advantage, the width of the aperture may be such that the body of an 8-channel pipette held parallel to the width of the aperture would rest on an edge of the aperture and would not fall through the aperture.

The wall 206 connects the base 202 with the pipette support 204. The pipette support 204 is connected to the wall 206 using a fastener 214 described below with respect to FIG. 2B. The wall 206 may be a solid structure connecting the base 202 with the pipette support 204. The wall 206 may comprise any structure that connects the base 202 with the pipette support 204 and that is sufficiently rigid to support the pipette support 204. The base 202 may rest on a surface (a work bench, e.g.). The wall 206 may be a solid structure or may contain legs or feet for supporting device 200. The base 202 may comprise any structure connected to the wall 206 and may stably support the wall 206 and pipette support 204.

As an exemplary advantage, the connection of the wall 206 to the base 202 and pipette support 204 may allow device 200 to be manufactured as two units, thereby decreasing the cost for manufacturing or increasing durability of device 200. As a further exemplary advantage, the connection of components of device 200 may allow it to be transported easily. Thus, as a further exemplary advantage, the connection of components of device 200 may allow it to be portable. As a further exemplary advantage, the connection of components of device 200 may allow the device to stand without external aid, such as on a table or bench.

A distance D between the pipette support 204 and the base 202 is adjustable. The distance between the pipette support 204 and the base 202 may be manually adjustable. As an exemplary advantage, a user may adjust the pipette support 204 manually, such as up and down, to a desired distance D. As a further exemplary advantage, the user may adjust the distance D quickly and reproducibly.

The distance D between the pipette support 204 and the base 202 is between 30 and 200 mm. The distance D between the pipette support 204 and the base 202 may be approximately the length of a pipette tip, e.g., a 2 μL, 10 μL, 20 μL, 200 μL, 200 μL, or 1 mL pipette tip. The distance D between the pipette support 204 and the base 202 may be between 74 and 127 mm.

As an exemplary advantage, the distance D between the pipette support 204 and the base 202 may be such that a pipette tip attached to a multi-channel pipette with its body resting on an edge of the aperture 208 extends to a desired distance above wells of a multi-well plate below the aperture 208. As a further exemplary advantage, the distance D between the pipette support 204 and the base 202 may be such that a pipette tip attached to a multi-channel pipette with its body resting on an edge of the aperture 208 extends to a desired depth within wells of a multi-well plate below the aperture 208. As a further exemplary advantage, distal ends of the tips may align at approximately the same distance from the bottom of respective wells of a multi-well plate.

FIG. 2B illustrates exemplary device 200 from an alternate perspective. The pipette support 204 is attached to the wall 206 with a fastener 214 that extends through the wall 206. An attachment force between the pipette support 204 and the wall 206 is adjustable. The attachment force may be adjustable over a range. For example, at a minimum attachment force, the pipette support 204 may not be fixedly attached to the wall 206 so that the pipette support 204 can move relative to the wall 206. At a maximum force, the pipette support 204 may be immobile relative to the wall 206 when subjected to moderate human force. At intermediate forces, the pipette support 204 may be moveable relative to the wall 206 under moderate human force. The attachment force between the pipette support 204 and the wall 206 may be manually adjustable. The fastener 214 may be a screw or knob. The fastener 214 may clamp the pipette support 204 to the wall 206 at a desired distance D from the base 202.

As an exemplary advantage, the fastener 214 may be adjustable or removable, allowing for removal of the pipette support 204 or adjustment of the pipette support 204 relative to the base 202. As a further exemplary advantage, the pipette support 204 may be attached over a range of distances D relative to the base 202.

A protrusion 216 extends from the pipette support 204 through the wall 206. As an exemplary advantage, the protrusion 216 may maintain the pipette support 204 in a position parallel to the base 202. The wall 206 may contain preset grooves or holes with tabs for stabilizing or fixing the pipette support 204 over the range of distances relative to the base 202. The pipette support 204 may be supported by a protrusion attached to the wall 206. As will be readily understood by one of ordinary skill in the art, other structural features could stabilize the pipette support 204 relative to the wall without deviating from the scope of this disclosure.

A surface of the wall 206 contains markings 218 indicating a distance D between the pipette support 204 and the base 202. The markings 218 may include a scale that indicates a value relative to the distance D between the pipette support 204 and the base 202. The distance D may be indicated by the location of the fastener 214 or protrusion 216 relative to the values of the markings 218.

As an exemplary advantage, the markings 218 may allow for the distance D between the pipette support 204 and the base 202 to be known, recorded, or controlled. As a further exemplary advantage, the distance D between the pipette support 204 and the base 202 may be reproducible. The distance D may be returned to a desired distance D1 following adjustment to a different distance D2, such as after use by another user or for a different experimental protocol.

Returning to FIG. 2A, device 200 includes a stabilizing element 220. The stabilizing element 220 may include more than one component, such as a clip, clasp, or screw. The stabilizing element 220 may be flexible. The stabilizing element 220 may be adjustable. A component of the stabilizing element 220 may be spaced approximately 85 mm from another component of the stabilizing element 220. A component of the stabilizing element 220 may be spaced approximately 127 mm from another component of the stabilizing element 220.

The spacing of the components of the stabilizing element 220 from one another may be approximately the width or length of a multi-well plate. Components of the stabilizing element 220 may be located at both ends of the width of the plate, both ends of the length of the plate, or a combination thereof. The stabilizing element 220 may be aligned with the aperture 208 of the pipette support 204. Thus, components of the stabilizing element 220 may delineate an area in which to place the multi-well plate, such as below the aperture 208 of the pipette support 204. The stabilizing element 220 may contain a spring or other adjustable component. Thus, the stabilizing element 220 may be adjusted to allow for the placement of a plate below the aperture 208 of the pipette support 204 and readjusted to secure the plate.

As an exemplary advantage, the stabilizing element 220 may serve as a guide for the placement of a multi-well plate below the aperture 208 of the pipette support 204. As a further exemplary advantage, the stabilizing element 220 may serve to secure a multi-well plate on a surface, such as the base 202, such that it does not change positions or slide off of the surface.

The base 202 is fixed relative to the wall 206. The wall 206 is perpendicular to the base 202 or the pipette support 204.

As an exemplary advantage, when components of device 200 are fixed, the variability of the orientation of the components with respect to one another may be reduced. As a further exemplary advantage, device 200 may stand without external support, such as on the surface of a bench or table.

The dimensions of device 200 are approximately 194 mm length×158 mm width×138 mm height, with the wall having dimensions of approximately 194 mm length×134 mm height, and the pipette support and base having dimensions of approximately 194 mm length×138 mm width. The area occupied by device 200 is in a range from approximately 3030 mm³ to approximately 4229 mm³ or does not exceed approximately 18000 mm³. Device 200 may be lightweight. The mass of device 200 may be between 500 g and 950 g.

As an exemplary advantage, device 200 may occupy less space on a table or bench than another device, such as an automated pipetting system. As a further exemplary advantage, device 200 may weigh less than another device, such as an automated pipetting system. As a further exemplary advantage, the size or mass of device 200 may facilitate the ability of a user to transport, move, or store device 200. Thus, as a further exemplary advantage, device 200 may be portable. As a further exemplary advantage, device 200 may not require a power source such as electricity. In other embodiments, the device may include a power source such as electricity.

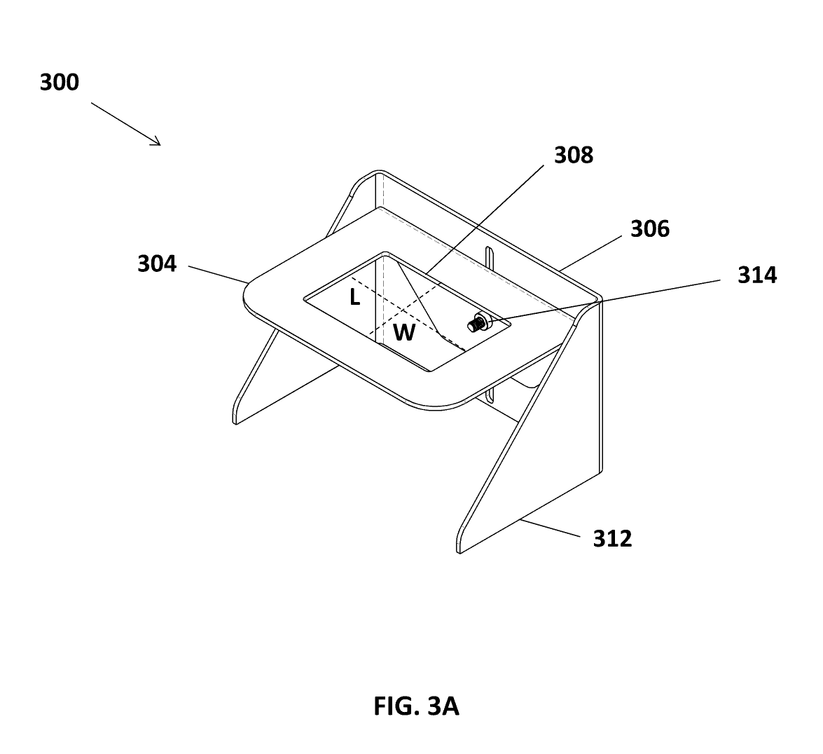

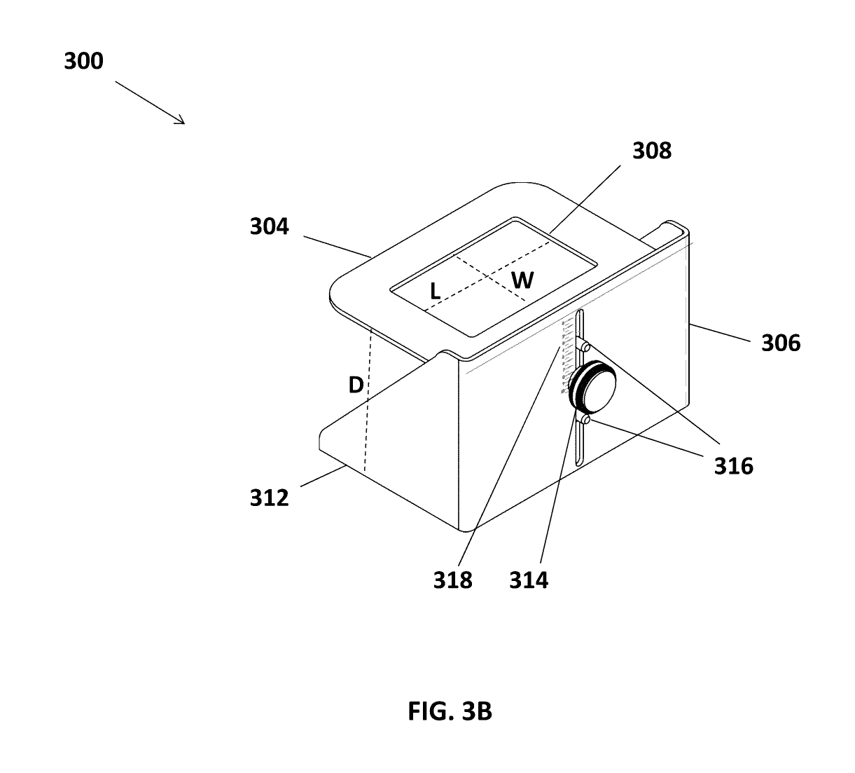

FIG. 3A illustrates an exemplary device 300 in accordance with an embodiment. Device 300 includes a pipette support 304, a wall 306, and side-walls 312. The pipette support 304 has an aperture 308. A width W of the aperture 308 is within a range of 70 to 90 mm. A length L of the aperture 308 is within a range of 100 to 140 mm. The wall 306 connects the side wall 312 to the pipette support 304. A distance D between the pipette support 304 and a base of the side wall 312 is adjustable.

As an exemplary advantage, device 300 may cost less than other automated or semi-manual devices for pipetting. As a further exemplary advantage, device 300 may result in the even extension of pipette tips into wells of a multi-well plate. As a further exemplary advantage, this may result in even or consistent aspiration of supernatant from wells of the plate. As a further exemplary advantage, this may prevent disruption of a pellet in wells of the plate. As a further exemplary advantage, device 300 may be portable. As a further exemplary advantage, device 300 may take up less space than other devices for pipetting or may weigh less than other devices.

The pipette support 304 comprises an aperture 308. A width W of the aperture 308 is within a range of 70 to 90 mm. The width W of the aperture 308 may be within a range of 70 to 75 mm. A length L of the aperture 308 may be within a range of 100 to 140 mm. The length L of the aperture 308 may be within a range of 70 to 110 mm. The width W of the aperture 308 may be approximately 72 mm and the length L of the aperture 308 may be approximately 109 mm. The width W or the length L of the aperture 308 may be about the size of a body of a multi-channel pipette, e.g., an 8-channel or 12-channel pipette.

The aperture 308 may be rectangular. The width W or the length L of the aperture 308 may be dimensions of the rectangular aperture 308. The width W and length L of the aperture may be different for some embodiments. The minimum width W of an aperture may be approximately the size of the body of an 8-channel pipette. The maximum width W may be such that an 8-channel pipette aligned parallel to the width W would not fall through the aperture 308. The minimum length L of an aperture may be approximately the size of the body of a 12-channel pipette. The maximum length L may be such that a 12-channel pipette aligned parallel to the length L would not fall through the aperture 308.

In some embodiments, the aperture is not rectangular. In those embodiments, the width W of an aperture may be understood to include any two points on the perimeter of the aperture that is sufficiently wide to permit tips attached to an 8-channel pipette to pass through and sufficiently narrow so that a body of an 8-channel pipette can rest on the two points. In those embodiments, the length L of an aperture may be understood to include any two points on the perimeter of the aperture that is sufficiently wide to permit tips attached to a 12-channel pipette to pass through and sufficiently narrow so that a body of a 12-channel pipette can rest on the two points. Some non-rectangular apertures may have more than one width W and more than one length L.

As an exemplary advantage, when the body of a multi-channel pipette is rested on an edge of the aperture, a length of the body of the pipette may be parallel with rows or columns of a multi-well plate, for example, such that distal ends of tips attached to the pipette are at an equal distance from the bottom of respective wells of the multi-well plate when it is placed below the aperture. As a further exemplary advantage, the length of the aperture may be such that the body of a 12-channel pipette held parallel to the length of the aperture would rest on an edge of the aperture and would not fall through the aperture. As a further exemplary advantage, the width of the aperture may be such that the body of an 8-channel pipette held parallel to the width of the aperture would rest on an edge of the aperture and would not fall through the aperture.

The wall 306 connects the side wall 312 with the pipette support 304. The pipette support 304 is connected to the wall 306 using a fastener 314 described below with respect to FIG. 3B. The wall 306 may be a solid structure connecting the side-walls 312 with the pipette support 304. The wall 306 may comprise any structure that connects the side-walls 312 with the pipette support 304 and that is sufficiently rigid to support the device 300.

The side-walls 312 may comprise a base sufficient to support device 300. In some embodiments, the base of the side-walls may be the bottom of the side-walls. The base of the side wall 312 may rest on a surface (a work bench, e.g.). The wall 306 or the side wall 312 may be a solid structure or may contain legs or feet for supporting device 300. The side wall 312 may comprise any structure connected to the wall 306 and may stably support the wall 306 and pipette support 304.

As an exemplary advantage, the connection of the wall 306 to the side wall 312 and pipette support 304 may allow device 300 to be manufactured as two units, thereby decreasing the cost for manufacturing or increasing durability of device 300. As a further exemplary advantage, the connection of components of device 300 may allow it to be transported easily. As a further exemplary advantage, the connection of components of device 300 may allow it to be portable. As a further exemplary advantage, the connection of components of device 300 may allow the device to stand without external aid, such as on a table or bench.

A distance D between the pipette support 304 and the base of the side wall 312 is adjustable. The distance between the pipette support 304 and the base of the side wall 312 may be manually adjustable. As an exemplary advantage, a user may adjust the pipette support 304 manually, such as up and down, to a desired distance D. As a further exemplary advantage, the user may adjust the distance D quickly and reproducibly.

The distance D between the pipette support 304 and the base of the side wall 312 is between 30 and 200 mm. The distance D between the pipette support 304 and the base of the side wall 312 may be approximately the length of a pipette tip, e.g., a 2 μL, 10 μL, 20 μL, 200 μL, 200 μL, or 1 mL pipette tip. The distance D between the pipette support 304 and the base of the side wall 312 may be between 74 and 127 mm.

As an exemplary advantage, the distance D between the pipette support 304 and the base of the side wall 312 may be such that a pipette tip attached to a multi-channel pipette with its body resting on the edge of the aperture 308 extends to a desired distance above wells of a multi-well plate below the aperture 308. As a further exemplary advantage, the distance D between the pipette support 304 and the base of the side wall 312 may be such that a pipette tip attached to a multi-channel pipette with its body resting on an edge of the aperture 308 extends to a desired depth within wells of a multi-well plate below the aperture 308. As a further exemplary advantage, distal ends of the tips may align at approximately the same distance from the bottom of respective wells of a multi-well plate.

FIG. 3B illustrates exemplary device 300 from an alternate perspective. The pipette support 304 is attached to the wall 306 with a fastener 314 that extends through the wall 306. An attachment force between the pipette support 304 and the wall 306 is adjustable. The attachment force may be adjustable over a range. For example, at a minimum attachment force, the pipette support 304 may not be fixedly attached to the wall 306 so that the pipette support 304 can move relative to the wall 306. At a maximum force, the pipette support 304 may be immobile relative to the wall 306 when subjected to moderate human force. At intermediate forces, the pipette support 304 may be moveable relative to the wall 306 under moderate human force. The attachment force between the pipette support 304 and the wall 306 may be manually adjustable. The fastener 314 may be a screw or knob. The fastener 314 may clamp the pipette support 304 to the wall 306 at a desired distance D from the base of the side wall 312.

As an exemplary advantage, the fastener 314 may be adjustable or removable, allowing for removal of the pipette support 304 or adjustment of the pipette support 304 relative to the base of the side wall 312. As a further exemplary advantage, the pipette support 304 may be attached over a range of distances D relative to the base of the side wall 312.

A protrusion 316 extends from the pipette support 304 through the wall 306. As an exemplary advantage, the protrusion 316 may maintain the pipette support 304 in a position parallel to the base of the side wall 312. The wall 306 may contain preset grooves or holes with tabs for stabilizing or fixing the pipette support 304 over the range of distances relative to the base of the side wall 312. The pipette support 304 may be supported by a protrusion attached to the wall 306. As will be readily understood by one of ordinary skill in the art, other structural features could stabilize the pipette support 304 relative to the wall without deviating from the scope of this disclosure.

A surface of the wall 306 contains markings 318 indicating a distance D between the pipette support 304 and the base of the side wall 312. The markings 318 may include a scale that indicates a value relative to the distance D between the pipette support 304 and the base of the side wall 312. The distance D may be indicated by the location of the fastener 314 or protrusion 316 relative to the values of the markings 318.

As an exemplary advantage, the markings 318 may allow for the distance D between the pipette support 304 and the base of the side wall 312 to be known, recorded, or controlled. As a further exemplary advantage, the distance D between the pipette support 304 and the base of the side wall 312 may be reproducible. The distance D may be returned to a desired distance D1 following adjustment to a different distance D2, such as after use by another user or for a different experimental protocol.

The side wall 312 is fixed relative to the wall 306. The wall 306 is perpendicular to the side wall 312 or the pipette support 304.

As an exemplary advantage, when components of device 300 are fixed, the variability of the orientation of the components with respect to one another may be reduced. As a further exemplary advantage, device 300 may stand without external support, such as on the surface of a bench or table.

The dimensions of device 300 are approximately 194 mm length×158 mm width×138 mm height, with the wall having dimensions of approximately 194 mm length×134 mm height, and the pipette support having dimensions of approximately 194 mm length×138 mm width. The volume occupied by device 300 is in a range from approximately 3030 mm3 to approximately 4229 mm3 or does not exceed approximately 18000 mm3. Device 300 may be lightweight. The mass of device 300 may be between 500 g and 950 g.

As an exemplary advantage, device 300 may occupy less space on a table or bench than another device, such as an automated pipetting system. As a further exemplary advantage, device 300 may weigh less than another device, such as an automated pipetting system. As a further exemplary advantage, device 300 may be portable. As a further exemplary advantage, the size or mass of device 300 may facilitate the ability of a user to transport, move, or store device 300. As a further exemplary advantage, device 300 may not require a power source such as electricity.

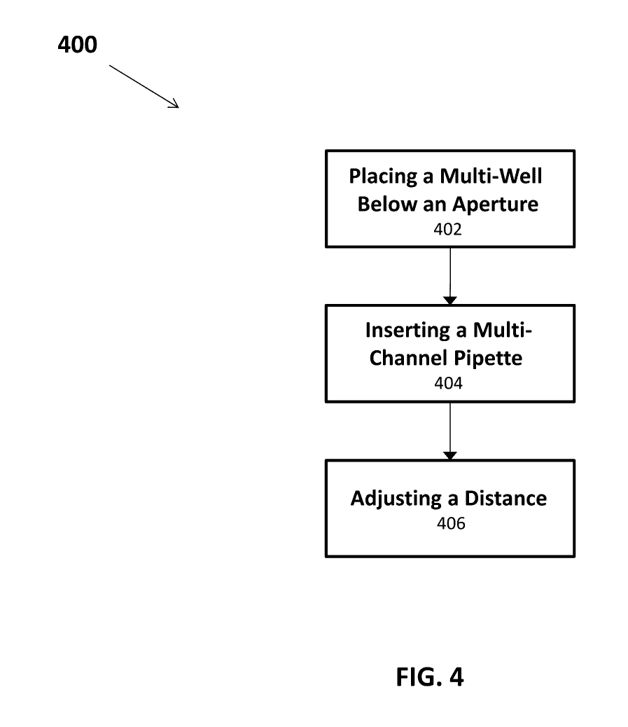

FIG. 4 illustrates exemplary method 400 of pipetting. Method 400 includes placing a multi-well plate below an aperture of a pipette support 402, inserting a multi-channel pipette comprising pipette tips into the aperture 404, and adjusting a distance between the pipette support and the multi-well plate 406.

In some embodiments, the pipette is inserted into the aperture such that the body of the pipette rests on an edge of the aperture with the tips extending through the aperture. In some embodiments, the aperture has a width within a range of 70 to 90 mm. In some embodiments, the aperture has a length within a range of 100 to 140 mm. In some embodiments, the width of the aperture is about 72 mm and the length of the aperture is about 109 mm. In some embodiments, the width or the length of the aperture may be about the size of the multi-channel pipette, e.g., an 8-channel or 12-channel pipette.

As an exemplary advantage, when the body of the multi-channel pipette is rested on an edge of the aperture, the body of the pipette may be parallel with a row or column of the plate, for example, such that distal ends of the tips are at an equal distance from the bottom of respective wells. As a further exemplary advantage, the length of the aperture may be such that the body of a 12-channel pipette held parallel to the length of the aperture would rest on an edge of the aperture and would not fall through the aperture. As a further exemplary advantage, the width of the aperture may be such that the body of an 8-channel pipette held parallel to the width of the aperture would rest on an edge of the aperture and would not fall through the aperture.

In some embodiments, the method includes adjusting a distance between the pipette support and a base. In some embodiments, the distance is manually adjusted by a user, such as a human being. In some embodiments, the method includes adjusting an attachment force between the base and a wall. In some embodiments, the base is attached to the wall with a fastener that extends through the wall. In some embodiments, a protrusion extends from the base through the wall.

In some embodiments, the method includes decreasing the attachment force between the base and the wall, such as by loosening the fastener, manually adjusting the base to increase or decrease the distance between the base and the pipette support, and increasing the attachment force, such as by tightening the fastener.

In some embodiments, the method includes adjusting a distance between the pipette support and a base. In some embodiments, the distance is manually adjusted by a user, such as a human being. In some embodiments, the method includes adjusting an attachment force between the pipette support and a wall. In some embodiments, the pipette support is attached to the wall with a fastener that extends through the wall. In some embodiments, a protrusion extends from the pipette support through the wall.

In some embodiments, the method includes decreasing the attachment force between the pipette support and the wall, such as by loosening the fastener, manually adjusting the pipette support to increase or decrease the distance between the pipette support and the base, and increasing the attachment force, such as by tightening the fastener.

In some embodiments, the distance between the pipette support and the base is adjusted to between 30 and 200 mm. In some embodiments, the distance between the pipette support and the base may be adjusted to about the length of a pipette tip, e.g., a 2 μL, 10 μL, 20 μL, 100 μL, 200 μL, or 1 mL pipette tip. In some embodiments, the distance between the pipette support and the base may be adjusted to between about 74 mm and about 127 mm.

As an exemplary advantage, the distance may be adjusted to accommodate the use of various sizes of pipette tips. As a further exemplary advantage, the distance may be adjusted to accommodate various experimental protocols. As a further exemplary advantage, the distance may be adjusted to accommodate various volumes of compositions to be dispensed into or aspirated from the wells.

In some embodiments, a surface of the wall contains markings indicating a distance between the pipette support and the base. In some embodiments, the markings are a scale that indicates a value relative to the distance between the pipette support and the base. In some embodiments, the distance is indicated by the location of the fastener or protrusion relative to the values on the scale. In some embodiments, the distance between the pipette support and the base is adjusted such that the fastener or protrusion aligns with a desired marking on the wall.

As an exemplary advantage, the markings may allow for the distance between the pipette support and the base to be known, recorded, or controlled. As a further exemplary advantage, the distance between the pipette support and the base may be reproducible. As a further exemplary advantage, the distance may be returned to a desired distance following adjustment to a different distance, such as after use by another user or for a different experimental protocol.

In some embodiments, the method includes placing the multi-well plate in a stabilizing element. As an exemplary advantage, the stabilizing element may serve as a guide for the placement of a multi-well plate below the aperture of a pipette support. In some embodiments, the stabilizing element is adjusted such that a multi-well plate resting below the aperture is aligned with the aperture of the pipette support. As a further exemplary advantage, the stabilizing element may serve to secure a multi-well plate on a surface, such as the base, such that it does not change positions or slide off of the surface.

In some embodiments, the method includes positioning the tips above wells of the multi-well plate. In some embodiments, the method includes positioning the tips within wells of the multi-well plate. In some embodiments, the method includes dispensing a composition into wells of the multi-well plate. In some embodiments, the method includes aspirating a composition from wells of the multi-well plate.

As an exemplary advantage, the method may allow for alignment of the pipette tips above wells of the plate such that approximately the same amount of a composition is dispensed into all wells of a row or column of the plate. As a further exemplary advantage, the method may allow the aspiration of approximately the same amount of a composition from each of the wells of a row or column of the plate. As a further exemplary advantage, the method may result in better reproducibility of volumes dispensed into the wells or volumes aspirated from the wells than an alternative method, such as manual pipetting without the use of a device. As a further exemplary advantage, the method may allow for aspiration of a composition, such as a supernatant, from the wells without disturbing a pellet contained within the wells, such as that resulting from centrifugation of the plate.

In some embodiments, the method includes removing the pipette from the aperture, and re-inserting the pipette into the aperture. In some embodiments, the tips are ejected from the pipette and fresh tips are attached. In some embodiments, the pipette support contains markings or grooves to facilitate placement of the pipette on an edge of the aperture.

As an exemplary advantage, the method may result in better alignment of the pipette tips above the wells, or within the wells as compared to other methods. As a further exemplary advantage, the methods may allow for more consistent pipetting. As a further exemplary advantage, the method may result in reduced pipetting error. As a further exemplary advantage, the method may decrease training time, such as by decreasing the advanced techniques that may be associated with pipetting by other methods.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims. It should be understood that the various embodiments have been presented by way of example only, and not by way of limitation. Likewise, the various diagrams may depict an example architectural or other configuration for the embodiments, which is done to aid in understanding the features and functionality that can be included in the disclosed embodiments. The disclosure is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described. They instead can, be applied, alone or in some combination, to one or more of the other embodiments of the invention, whether or not such embodiments are described, and whether or not such features are presented as being a part of a described embodiment. Thus the breadth and scope of the invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. The presence of broadening words and phrases such as “one or more,” “at least,” “but not limited to”, or other like phrases in some instances shall not be read to mean that the narrower case is intended or required in instances where such broadening phrases may be absent.

1. A device comprising:
a pipette support comprising an aperture, wherein a width of the aperture is within a range of 70 to 90 mm and a length of the aperture is within a range of 100 to 140 mm;
a base, wherein a distance between the pipette support and the base is adjustable;
a wall connecting the base with the pipette support; and
an adjustable multi-well plate stabilizing element.

2. The device of claim 1, wherein the distance between the pipette support and the base is adjustable over a range from 30 mm to 200 mm.

3. The device of claim 1, wherein a surface of the wall comprises markings indicating a changeable distance between the base and the pipette support.

4. (canceled)

5. The device of claim 1, wherein the wall is perpendicular to at least one selected from the group consisting of the base and the pipette support.

6. The device of claim 1, wherein the device is portable.

7. The device of claim 1, wherein the base is moveable relative to the wall.

8. The device of claim 7, wherein the base is attached to the wall with a fastener that extends through the wall, and wherein a protrusion extends from the base through the wall.

9. The device of claim 7, wherein an attachment force between the base and the wall is adjustable.

10. The device of claim 7, wherein the pipette support is fixed relative to the wall.

11. The device of claim 1, wherein the pipette support is moveable relative to the wall.

12. The device of claim 11, wherein the pipette support is attached to the wall with a fastener that extends through the wall, and wherein a protrusion extends from the pipette support through the wall.

13. The device of claim 11, wherein an attachment force between the pipette support and the wall is adjustable.

14. The device of claim 11, wherein the base is fixed relative to the wall.

15. A method of pipetting comprising:
placing a multi-well plate below an aperture of a pipette support on a base moveable relative to a wall, wherein the aperture comprises a width within a range of 70 to 90 mm and a length within a range of 100 to 140 mm;
inserting a multi-channel pipette comprising pipette tips into the aperture such that a body of the multi-channel pipette rests on an edge of the aperture; and
adjusting a distance between the pipette support and the multi-well plate by adjusting an attachment force between the base and the wall, wherein the base is attached to the wall with a fastener that extends through the wall, and wherein a protrusion extends from the base through the wall.

16. The method of claim 15, wherein the distance between the pipette support and the multi-well plate is adjusted to between 30 and 200 mm.

17. The method of claim 15, wherein placing a multi-well plate below an aperture of a pipette support further comprises placing the multi-well plate in a stabilizing element.

18. The method of claim 15, further comprising positioning the pipette tips above wells of the multi-well plate or positioning the tips within wells of the multi-well plate.

19. The method of claim 15, further comprising dispensing a composition into wells of the multi-well plate or aspirating a composition from wells of the multi-well plate.

20. The method of claim 15, further comprising removing the pipette from the aperture and re-inserting the pipette into the aperture.

21. (canceled)

22. A method of pipetting comprising:
placing a multi-well plate below an aperture of a pipette support, wherein the aperture comprises a width within a range of 70 to 90 mm and a length within a range of 100 to 140 mm;
inserting a multi-channel pipette comprising pipette tips into the aperture such that a body of the multi-channel pipette rests on an edge of the aperture; and
adjusting a distance between the pipette support and the multi-well plate by adjusting an attachment force between the pipette support and a wall, wherein the pipette support is attached to the wall with a fastener that extends through the wall, wherein a protrusion extends from the pipette support through the wall, and wherein the pipette support is moveable relative to the wall.
